(19) United States
(12) Patent Application Publication
(10) Pub. No.: US 2008/0027892 A1
(43) Pub. Date: Jan. 31, 2008

(54) DYNAMIC STREAM FILE SYSTEM NETWORK SUPPORT

(75) Inventors: Jason D. Carnahan, Boise, ID (US); Steven T. Baker, Salt Lake City, UT (US); Benjamin A. Kendall, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: KESTRELINK CORPORATION, Boise, ID (US)

(21) Appl. No.: 11/460,375

(22) Filed: Jul. 27, 2006

(51) Int. Cl. G06F 17/30

(52) U.S. Cl. 707/1

(57) ABSTRACT

Accessing data from large, unknown size, or streaming files. A method includes acts for accessing files. A request is received to read at a virtual address corresponding to an identifier for a file or directory. The virtual address is read to read a shared address range from the virtual address. The shared address range can be used for a number of files or directories. One of the files or directories may be selected for use at a given time based on the identifier for the file or directory. The shared address range is returned in response to the request. File or directory content data is accessed by means of a read request, received for an address in the shared address range, wherein the shared address range comprises a finite address range, and wherein the shared address range is circular such that if a file or directory exceeds the size of the finite address range, portions exceeding the finite address range can be addressed starting at the beginning of the shared address range.

### BACKGROUND

### Background and Relevant Art

Computers and computing systems have affected nearly every aspect of modern living. Computers are generally involved in work, recreation, healthcare, transportation, entertainment, household management, etc. As computers become more widely used, digital data also becomes more prevalent and more desirable. For example, digital data can be used to represent audio and video signals. Music on CDs is stored digitally. Audio and video on DVDs is also stored digitally. Television signals provided over cable and satellite systems is generally provided in a digital format. In many areas, digitally encoded television signals can even be received from traditional over the air (OTA) broadcasters that have previously only broadcast analog signals.

Because this data can be stored digitally, individuals have begun using media servers where audio, video, and image data is stored on a computer system, central server or other central storage. This allows the user to have a repository of multimedia data. The user can then play or display the multimedia data directly from the computer, or send the data over the network to another computer or multimedia player through a network connection.

Often a media server will store a large number of files. To select a file to access, a user at a multimedia player must have some indication of the files at the media server. This often requires a transfer across a network of information about the files on the media server to the multimedia player. Because of the large number of files stored at the media server, information about all files stored at the server is not sent to the multimedia player prior to displaying the information about the media files to a user. Instead, as a user tries to request a portion of data describing the media files, the data describing the media files is sent from the media server to the multimedia adapter. Due to network traffic and congestion or bandwidth limitations on the network, some latencies may be experienced by a user as they attempt to page through a directory of media titles.

Additionally, some media files may be extremely large in size. In the case of streaming media, such as streaming video or audio, the final file size is unknown or unlimited in nature. This can create difficulties for multimedia players that expect a finite file size, and expect the file size to be within certain limits.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment may be embodied as a method practiced in a computing environment including a processor that accesses data from files that may be of an unknown file size, files with a file size larger than that allowed by a file system used by the processor, or streaming files with a potentially virtually unlimited file size. The method includes acts for accessing files. The method includes receiving a request to read at a virtual address corresponding to an identifier for a file or directory. The method further includes reading the virtual address to read a shared address range from the virtual address. The shared address range can be used for a number of files or directories. One of the files or directories may be selected for use at a given time based on the identifier for the file or directory. The method further includes returning the shared address range in response to the request. To access the actual file data read request is received for an address in the shared address range, wherein the shared address range comprises a finite address range, and wherein the shared address range is circular such that if a file or directory exceeds the size of the finite address range, portions exceeding the finite address range can be addressed starting at the beginning of the shared address range.

In another embodiment, computer readable media may be embodied in a computing environment including a processor that accesses data from files that may be of an unknown file size, files with a file size larger than that allowed by a file system used by the processor, or streaming files with a potentially unlimited file size. One or more computer readable media may include a number of data fields facilitating accessing files. The computer readable media may include a virtual first data structure, which may be for example a first portion of a file space address map. The virtual first data structure includes virtual addresses based on identifiers for one or more directories or files. A virtual second data structure, may also be included, for example as a second portion of the file space address map, where the data in the virtual first data structure is one or more shared address ranges of the virtual second data structure. The one or more shared address ranges are usable for addressing actual data for a file corresponding to an identifier directory depending on the reading of a virtual address based on the identifier. The shared address range comprises a finite address range. Additionally, the shared address range is circular such that if the addresses for the file or directory addressed in the first data structure exceed the size of the finite address range, portions exceeding the finite address range can be accessed by accessing addresses starting at the beginning of the shared address range.

In another embodiment, computer readable media may be embodied in a computing environment including a processor that accesses data from files that may be of an unknown file size, files with a file size larger than that allowed by a file system used by the processor, or streaming files with a potentially unlimited file size. One or more computer readable media including a number of data fields facilitating accessing files may be included. The computer readable media may include a first data structure, which may be for example a directory enumeration enumerating files and directories in a directory. The first data structure includes a first field including an enumeration of file or directory entries. The first data structure further includes a second field including an enumeration of type designators indicating whether an entry is a file or directory. The first data structure also includes a third field including identifiers corresponding to virtual addresses in a virtual second data structure. The virtual second data structure may be, for example, a first portion of a file space address map. The virtual second data structure includes mapping to a third virtual data structure, which may be for example, a second portion of the file space address map. The third virtual data structure includes one or more shared address ranges usable as addresses for directory or file addresses depending on the selection of a virtual address corresponding to an identifier for a directory or file.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an overview of a system for delivering media content to users;

FIG. 2 illustrates a block-diagram of a media player; and

FIG. 3 illustrates a dynamic file system.

### DETAILED DESCRIPTION

Embodiments herein may comprise a special purpose or general-purpose computer including various computer hardware, as discussed in greater detail below.

Some embodiments described herein allow large or unlimited files or directories to displayed or played by a media adapter by using a ring buffer shared address range for file data so as to accommodate the unknown size of the media file. However, once data has been played, the addresses in the ring buffer shared address range can be overwritten by subsequent data. Addressing for accessing data at a media server from a media adapter can be circular such that once all data in the buffer shared address range has been accessed, the beginning of the buffer can be accessed to access new data. Additionally, some embodiments include sharing of the ring buffer address range such that different directories share the same ring buffer address range. Similarly, different media files, such as audio, video, and image files, may share the same shared address range.

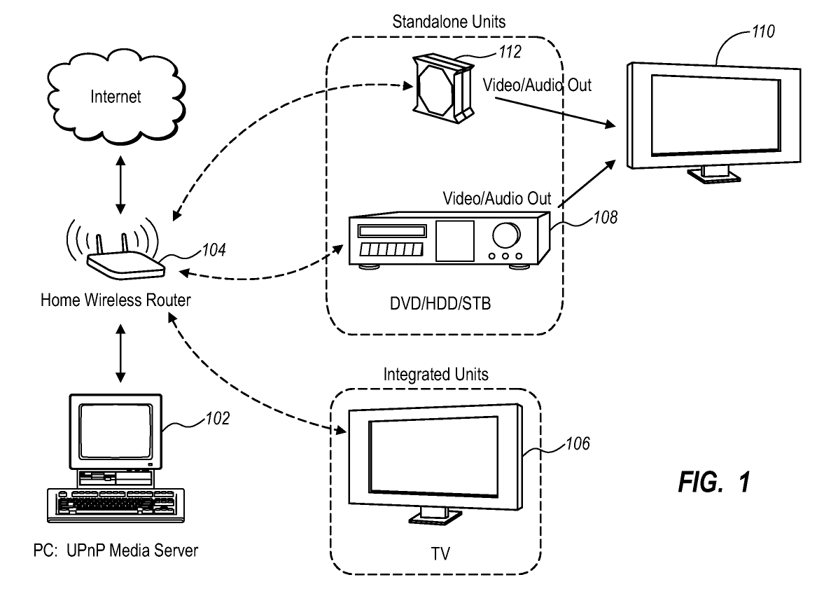

Referring now to FIG. 1, an exemplary environment where some embodiments of the invention may be practiced is illustrated. FIG. 1 illustrates a media server 102, which in this example is a universal plug and play (UPnP) server. The media server 102 may store various media files such as music files, video files, and picture files. Generally, the media server 102 is located in a local area network (LAN) and configured to provide the media files locally to clients. For example, in one embodiment, the media server 102 may be implemented in a home environment to provide media to home users. The file system storing media files and directories in the media server 102 may be a remote file system with respect to client computing devices as discussed in more detail below.

The media server 102 is connected through a router 104 to various clients on the network. The clients on the network may include specialized media adapters configured to provide media to users. As will be discussed further herein, the media adapters may include specialized hardware optimized for providing the media to users. For example, the media adapters may include processors that are optimized for decoding compressed audio, video or image data. The media adaptors may be embodied in a number of forms as illustrated in FIG. 1. For example, FIG. 1 illustrates an integrated media adapter integrated into a television 106. With this configuration, there is no need for an external box including the media adapter because the media adapter is integrated into the television where the media will be displayed or played.

FIG. 1 also illustrates a number of standalone units. For example, the media adapter may be integrated into a DVD player 108. This embodiment is particularly interesting as often the encoding typical on DVDs is the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further illustrates a self contained media adapter 112. The self contained media adapter 112 includes the specialized hardware for decoding and displaying media streamed from the media server 102. The self contained media adapter 112 is connected to the television 110 through audio and video connections.

Each of the examples of media adapters whether embodied in an integrated unit such as with the television 106, or a standalone unit such as the DVD player 108 or self contained media adapter 112, or other media adapter is connected, in this example, through the router 104 to the media server 102. The connections between the media server 102, router 104 and media adapters may be any suitable network connection including hardwired Ethernet connections, wireless wi-fi connections, or any other suitable connection. Notably some embodiments described herein optimize wireless network connections to maintain suitability for transmitting high bit rate media files.

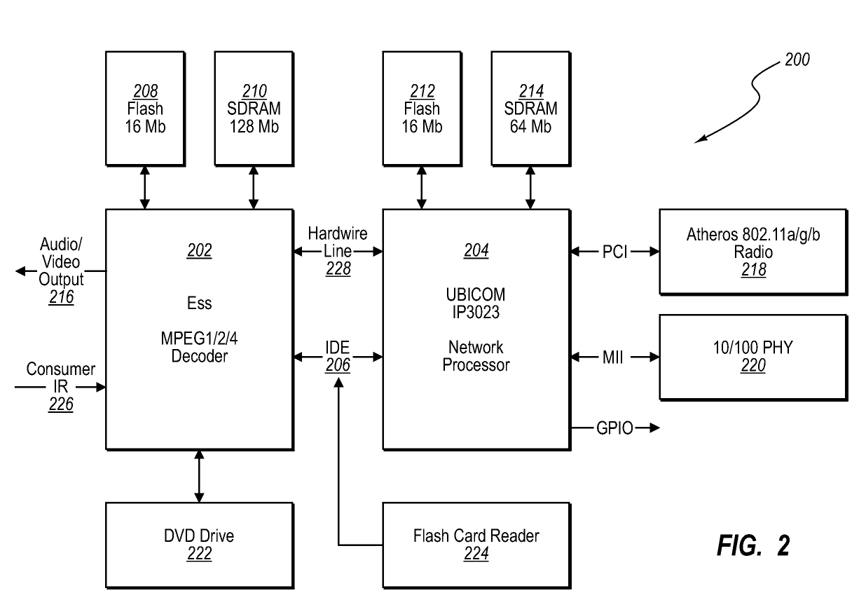

Referring now to FIG. 2, hardware from the media adapter is illustrated. As described previously, the media adapter 200 includes two processors coupled by an IDE bus. While an IDE bus is illustrated here, other storage device type busses may also be used. The media adapter 200 includes an mpeg decoder processor 202 coupled to a network processor 204 through an IDE bus 206. Each of the processors 202, 204 includes other appropriate peripheral hardware. For example, the decoder processor 202 is coupled to flash memory 208 and DRAM memory 210. The flash memory and DRAM memory 210 may store computer executable instructions such as computer applications to be executed on the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, etc.

Similar to the decoder processor 202, the network processor 204 has a flash memory 212 and a DRAM memory 214 connected to it. The flash memory 212 and DRAM memory 214 are computer readable media that may include computer executable instructions that can be executed by the network processor 204. In addition, the DRAM memory 214 may store data for delivery to the decoder processor 202. For example, the network processor 204 may receive data from a data store such as a media server, such as the media server 102. This data may be stored in the DRAM memory 214 for delivery to the decoder processor 202. Such data may include for example, media, file information, directory information, or other information. In the example illustrated, the network processor 204 may be connected to a media server through one or more different network connections.

FIG. 2 illustrates both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further illustrates that the network processor 204 may communicate with the media server through a wired connection such as by using a standard 10/100 Mbs (megabits per second) Ethernet adapter 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 illustrates two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is illustrated in FIG. 1 at 108.

FIG. 2 illustrates a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive. Any one of a number of removable and non-removable storage devices may be connected locally to the IDE bus 206 including but not limited to secure digital (SD) flash cards, compact flash (CF) flash cards, xD flash cards, on-board flash memory, on-board SRAM, on-board DRAM, IDE hard disk drives and the like.

Ordinarily, a storage device connected to a host processor through an IDE bus is somewhat passive in nature. In other words, typically the IDE device accepts commands from the host processor, and can be polled by the host processor for information, but does not typically provide data to the host processor without first being prompted. In the example shown in FIG. 2, the decoder processor 202 assumes the role of the processor and the network processor 204 assumes the role of the device in the IDE connection. To facilitate the network processor 204 providing information to the decoder processor 202, a hardware line 228 connects the two processors. If the network processor 204 has information to pass to the decoder processor 202, the network processor 204 can set the line signaling to the decoder processor 202 that the network processor 204 has information to pass to the decoder processor 202. The decoder processor 202 can then poll the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 polls the network processor 204, the network processor 204 can provide the diagnostic information.

To retrieve directory and file information, the decoder processor 202 requests data from the network processor 204 using the IDE interface 206. As such, the decoder processor 202 requests the data by providing an address and requesting a read from that address. Some embodiments described herein implement a virtual address mapping that allows the decoder processor 202 to use a shared address range along with an address corresponding to a file and/or directory identifier to access data using typical IDE file access techniques.

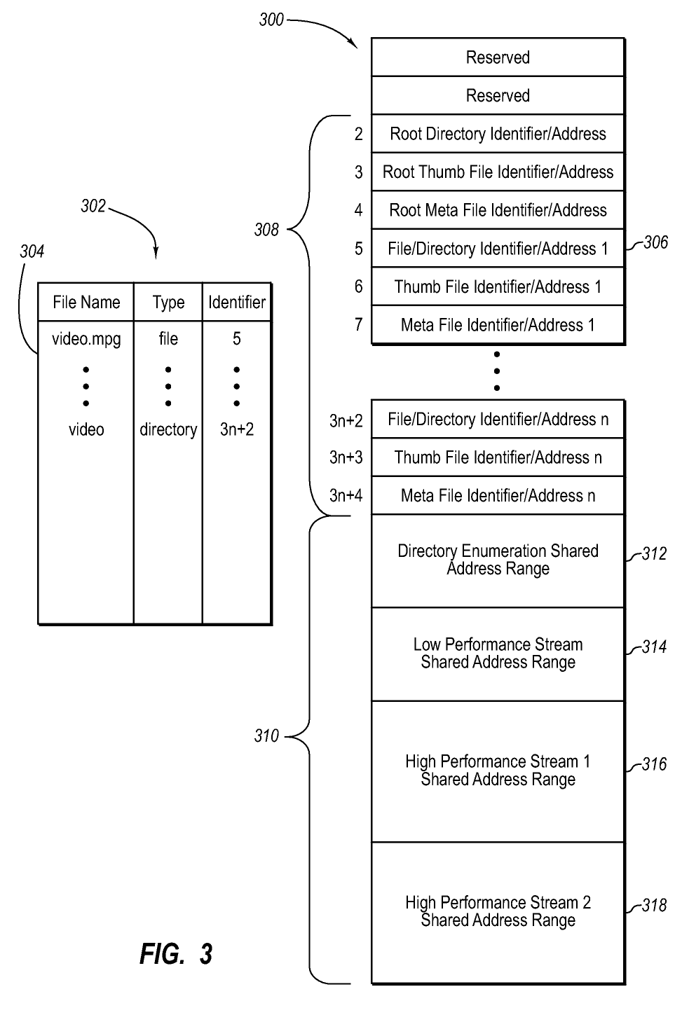

Referring now to FIG. 3, a block diagram illustrating a file space address map 300 is shown. In one embodiment, the file space address map 300 is a virtual address map implemented in the network processor 204 shown in FIG. 2. The file space address map 300 includes a virtual mapping of addresses for files and directories. To accomplish this, a first portion 308 of the file space address map 300 virtually correlates file and/or directory identifiers with status information and shared address mapping, as will be explained in more detail below. The first portion 308 can also be used to map additional information such as thumbnail file identifiers and addresses and metadata file identifiers and address corresponding to the file and/or directory identifiers. The second portion 310 of the file space address map 300 has shared address ranges which can be used by the decoder processor 202 to access content from a content location, such as a remote media server 102 (FIG. 1) or from a local storage device such as a flash drive connected at the flash card reader 224 (FIG. 2) for accessing files and directories. In particular, the second portion 310 includes four address ranges which will be described in more detail below. Suffice it to say, however, the four address ranges are fixed in address and size such that the decoder processor 202 may specify the same address for two different files. The network processor 204 is able to later determine, based on a previous request for information from the decoder processor 202 to the network processor, which file is actually being requested.

Associated with the file space address map 300 is a directory enumeration 302. The directory enumeration 302 includes entries for files and directories. The directory enumeration 302 may be located, for example, in the DRAM 210 connected to the decoder processor 202. Entries in the directory enumeration 302 include a file name (or directory name), a type (i.e. an indicator that the entry is for a file or directory), and an identifier. For example, FIG. 3 illustrates the first entry 304 in the directory enumeration 302. The first entry 304 in the directory enumeration 302 includes a file name, which in this case is video.mpg, a type indicator which in this case indicates that the file video.mpg is a file, and an identifier which in this case is 5. The identifier can be mathematically converted to an IDE compatible address which is one of the virtual addresses in the file space address map 300. Referring now to the file space address map 300, an address for the identifier 5 correlates with a first entry 306 in the file space address map 300. The first entry 306 stores an address for one of the shared address ranges in the second portion 310 of the file space address map 300. With the file space address map being a virtual address map, the entry is created dynamically as discussed in more detail below.

FIG. 3 illustrates that the file space address map 300 has the Root Directory Identifier/Address stored in a location corresponding to the identifier 2 of the file space address map 300. Notably, no corresponding entry is included in the directory enumeration 302. In the present example, the identifier for the Root Directory Identifier/Address is well known and known to be at the location corresponding to the identifier 2. This allows the decoder processor 202 to access the virtual file system at the network processor 204 to enumerate information in the directory enumeration 302 at start-up. Stated differently, the information in the directory enumeration 302 is populated by retrieving directory information from the network processor 204. This can be done by using information in the directory enumeration 302. However, at startup, there is no information in the directory enumeration 302 for the decoder processor to use to retrieve directory information from the network processor 204. This is not a problem, however, because the identifier for the root directory is well known, and as such, the network processor does not need to reference the directory enumeration 302 to obtain the identifier, but can rather simply convert the identifier for the root directory, in this case 2, to the appropriate IDE address, which will be used to populate the directory enumeration 302 with root directory entries, as will be explained in more detail below.

Other memory saving techniques, as discussed in more detail below, are also used. For example, it can be observed in FIG. 3 in one embodiment, each file or directory identifier/address has associated thumb file identifiers and addresses and associated meta file identifiers and addresses. Rather than storing file name, file type, and an identifier in the directory enumeration 302, the identifier can be deduced from assumptions. In particular, the identifier for the thumb file address in this example is m+1 and the identifier for the meta file address is m+2 where m is the identifier for the file or directory associated with the thumb file and the meta file. Thus, in one embodiment, the directory enumeration 302 includes file and directory identifiers explicitly, but thumb file identifiers and meta file identifiers are only included implicitly. While the example illustrated above includes a relationship where meta file identifiers and thumb file identifiers appear as subsequent identifiers to a related file or directory, other relationships may also be used.

FIG. 3 further illustrates a second portion 310 of the file space address map 300. The second portion 310 includes four virtual shared address ranges. Notably, the address ranges are shared such that different physical files will use the same address range. As stated previously, the second portion 310, in this example, includes four shared address ranges, a directory enumerations shared address range 312, a low performance stream shared address range 314, a first high performance stream shared address range 316, and a second high performance stream shared address range 318. The address ranges in the second portion 310 can be used by the decoder processor 202 to request actual data on a storage device. The directory enumeration shared address range 312 is specified in the particular example as being a 10 GB address range. Thus, the network processor 204 may store in physical memory a number representing a virtual beginning address and a number representing a virtual ending address. These virtual beginning and ending addresses are valued, in this example, such that they represent 10 GB of address space. Similarly, the low performance stream shared address range 314 may include virtual beginning and ending addresses that represent 10 GB of address space.

The first high performance stream shared address range 316 and the second high performance and stream shared address range 318 operate in a fashion similar to the low performance stream shared address range 314, except that the two high performance stream shared address ranges are used for high bandwidth media such as video files. Each of the high performance stream shared address ranges may include virtual beginning and ending addresses that represent 100 GB of address space. These values are only exemplary, and other shared address ranges may be used.

In the example illustrated, each of the four shared address ranges 312, 314, 316, and 318 are circular in nature and function essentially as large shared address ring buffers. Thus, for example, if a file or directory size exceeds the addresses allocated in the shared address range, excess addressing will be done by circling back onto the beginning of the shared address range. In other words, once the decoder processor 202 needs to request data beyond what can be represented by an address range it may request the additional data beginning at the beginning again of the shared address range.

In the examples illustrated herein, the low performance stream shared address range 314 has addresses accommodating 10 GB of data. The high performance stream shared address ranges 316 and 318 have addresses accommodating 100 GB of data. The size selections in these examples were done to allow for reasonable trick mode operation. For example, the selected sizes allow for reasonable fast forward and rewind capabilities. The sizes illustrated herein are exemplary, and other sizes may be used. For example, selected sizes may allow for a few minutes of trick mode operation or an hour or more of trick mode operation if the data rate is sufficiently low and the shared address range sufficiently large.

Directories can be opened for enumeration in directory enumeration 302. One functional example of directory enumeration will now be illustrated. This example will begin assuming that no data exists in the directory enumeration 302. In one example, the media adapter 200 may be just been turned on or reset. The decoder processor 202 knows that root directory identifier is 2. The decoder processor 202 converts this identifier to a virtual address in the file space address map 300. The decoder processor 202 then issues and IDE read request to the network processor 204 to read the calculated virtual address.

The network processor 204 then performs a virtual read of the calculated address. In the illustrated example, because only a single shared address range is used for directory addresses, namely the directory enumeration shared address range 312, any virtual read of a calculated address for a directory will result in the address range for the directory enumeration shared address range 312 being returned. Thus, the network processor 204 returns as a response to the decoder processors 202 read request, the address range for the directory enumeration shared address range 312. The decoder processor 202 can use this shared address range 312 to request directory information from the root directory to enumerate directory information into the directory enumeration 302. Because the decoder processor had previously requested a shared address range by reading the calculated address for the root directory, subsequent read requests to the directory enumeration shared address range 312 will result in information for the root directory being returned from the network processor 204 to the decoder processor. In particular, the network processor includes a data structure that correlates identifiers with network identifiers. The network identifier may be, for example, a serial number or other identifier for a particular directory or file that is known by both the network processor 204 and a data server such as the UPnP media server 102. Thus, when a directory is open for enumeration, the network processor 204 will use the network identifier to obtain data from the UPnP server 102. Notably, with only a single directory enumeration shared address range 312, in the illustrated embodiment, only a single directory is open for enumeration at any given time. If a new directory is opened for enumeration, then the previously opened directory is closed.

Once a portion of a directory has been enumerated in the directory enumeration 302, the information in the directory enumeration 302 may be used to open other directories for enumeration. Is should be noted at this point that the directory enumeration 302 does not necessarily contain the entire enumeration of the directory, but rather may be a predetermined amount for the directory up to some maximum. For example, the directory enumeration 302 may only store a maximum of 80 entries. Returning now to the present example, the directory enumeration 302 illustrates a directory titled “video” with an identifier of 3n+2. This identifier can be converted to the corresponding virtual address in the file space address map 300 shown in the first portion 308 and labeled 3n+2. This address space contains a virtual mapping to the directory enumeration shared address range 312 which is again returned to the decoder processor as the response to the request to read the address corresponding to 3n+2. Notably, this is the same response as for the root directory, however the network processor now knows that the directory “video” is open for enumeration instead of the root directory. Addresses within the virtual directory enumeration shared address range 312 can be used by the decoder processor 202 to request directory information for the video directory until another directory is opened for enumeration.

Once a calculated directory identifier address is read from the first portion 308, the directory enumeration shared address range 312 may be randomly accessed up to the end of the shared address range. In the example illustrated, the directory enumeration shared address range 312 may be randomly accessed up to a maximum of 10 GB.

To read actual directory entries, beginning at the beginning of the directory enumeration shared address range 312, the directory is accessed as specified. Directory entries can then be read sequentially according to the entries in the directory enumeration shared address range 312 until either all of the directory entries have been enumerated or until the end of the directory enumeration shared address range 312 is reached. If the end of the directory enumeration shared address range 312 is reached, then the next read address is the beginning of the directory enumeration shared address range 312. Circling back to the beginning of the directory enumeration shared address range 312 can be repeated as many times as needed to retrieve the desired directory information. Notably, in one embodiment, the network processor 204 may also contain a version of the directory enumeration 302. In particular, one embodiment includes a version of the directory enumeration 302 that is larger in capacity than the version of the directory enumeration 302 at the decoder processor. This allows the network processor 204 to buffer and cache directory information for the decoder processor.

Files can be opened for streaming using the low performance shared address range 314, the first high performance shared address range 316, and the second high performance shared address range 318. As such, up to three files for streaming may be open at any given time in the example illustrated in FIG. 3.

To open a file for streaming, the decoder processor 202 reads the identifier from the directory enumeration 302 and requests data from a calculated virtual address corresponding to the identifier. The network processor 204 reads the data at the calculated virtual address. Notably, the network processor includes an algorithm to determine which virtual address range is stored at the calculated virtual address. As such, the storage is dynamic in that the read process itself results in the selection of the shared address range. If the file identifier corresponds to a low bandwidth type stream, such as photos or music files, then the low performance stream shared address range 314 will be returned as the response to the request. If the file identifier corresponds to a higher bandwidth type stream, such as a movie, then one of the high performance stream shared address ranges, 316 or 318 will be returned. This can be selected for example, based on if one of the shared address ranges is already in use for buffering a file. Information is returned to the decoder processor 202 that allows the decoder processor to return to upper application layers the virtual file system address range information, and the status of the opened stream. The returned information may include, for example, beginning and ending file system addresses of the address range where the file can be accessed. Status information may also be returned, such as a status value and a percentage of the stream transferred, if know. For example, as with the directory case, a buffer may exist at the network processor 204. When the network processor 204 receives the request to read an address corresponding to an identifier, the network processor can not only return the shared address range, but can also begin buffering the file to reduce network delays when file data is requested.

In one embodiment, a file or directory can be randomly accessed up to the amount of shared address space. However, in one alternative embodiment, access of directory or file addresses may be extended past the shared address range by keeping track of the number of address range wraps and the direction of wrap to calculate a file, stream or directory offset.

Notably, various embodiments may include various error handling and file size handling features. For example, it is likely that the end of a file will not correspond with the end of the shared address space. Even if the end of the file did correspond with the end of the shared address space, it would be unknown which wrap of the shared address space would correspond with the end of the file. Thus, in one embodiment, the end of a file may be indicated by including an indicator. In one embodiment, this may be a NUL file entry.

Illustratively, in one embodiment, a methods may be embodied where it is detected the end of enumerated data in the shared address range has been requested. This may be accomplished by, in one embodiment, detecting a NUL file entry. The network processor 204 can respond to the request for the end of enumerated data in the shared address range with an error. In one embodiment, this may be accomplished by sending a general IDE error. Alternatively, the network processor may set the hardware line 228 to indicate the presence of an error. Other error signaling may additionally or alternatively be performed. The decoder processor 202 can respond to the network processor 204 with a request to define the error. The network processor 204 can then respond with an indication that error indicated the end of enumerated data in the shared address range. This information can be used by upper application layers for applications running on the decoder processor 202.

Other error handling may also be accounted for. For example, in one embodiment, the network processor 204 may detect that a request is being made for data beyond the range of the actual directory or file data, but within the shared address range. The network processor 204 may respond to the request for data beyond the range of actual data in the shared address range with an error propagated in an appropriate fashion, such as those described above. The decoder processor 202 may request the network processor 204 to define the error. The network processor responds with an indication that the request for data is beyond the range of enumerated data in the shared address range. This information can be used by upper application layers for applications running on the decoder processor 202.

The network processor 204 and decoder processor 202, alone or in combination, may be also able to detect an invalid content source. The content source may be invalid because of at least one of a remote data store being removed from a network, a remote data store being powered down, a remote data store being overloaded, network limitations, network accessibility, etc. When an invalid content source is detected, an error can be reported. A request is then received to define the error. A response to the error with an indication that the content source is invalid can be generated. Additionally, if the reason for the invalidity of the content source can be detected, then that information can be returned as well.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Notably, some embodiments may be embodied using a combination of computer readable media and computer executable instructions being consumed by a processor. For example, the file space address map 300 may be implemented as a virtual structure that includes two data structures. The first data structure includes the virtual addresses corresponding to identifiers as shown in the first portion 308. The second data structure includes the shared address ranges in the second portion 310. Notably, the addresses in the first portion include virtual data which is actually generated dynamically. Specifically, the shared address range that is returned as data is generated dynamically when the virtual address corresponding to the identifier is read as explained in the examples above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including a processor that accesses data from files that may be of an unknown file size, files with a file size larger than that allowed by a file system used by the processor, or streaming files with a potentially virtually unlimited file size, a method of accessing files, the method comprising:
receiving a request to read at a virtual address corresponding to an identifier for a file or directory;
reading the virtual address to read a shared address range from the virtual address, wherein the shared address range can be used for a plurality of files or directories, wherein one of the plurality of files or directories is selected for use at a given time based on the identifier for the file or directory;
returning the shared address range in response to the request; and
receiving a read request for an address in the shared address range, wherein the shared address range comprises a finite address range, and wherein the shared address range is circular such that if a file or directory exceeds the size of the finite address range, portions exceeding the finite address range can be addressed starting at the beginning of the shared address range.

2. The method of claim 1, wherein a plurality of files or directories share the shared address range, the method further comprising closing a first file or directory and opening a second file or directory using the shared address range when the act of reading the virtual address to read a shared address range comprises reading the virtual address corresponding to the identifier for the second file or directory.

3. The method of claim 1, further comprising in response to receiving a read request for an address in the shared address range, providing data from a file or directory corresponding to the identifier using the data being based on the address in the shared address range.

4. The method of claim 1, further comprising:
detecting that a request is being made for data beyond the range of actual data;
responding to the request for data beyond the range of actual data with an error;
receiving a request to define the error;
responding with an indication that the request for data is beyond the range of actual data.

5. The method of claim 1, further comprising:
detecting that the end of actual data has been requested;
responding to the request for the end of actual data with an error;
receiving a request to define the error;
responding with an indication that the error signifies that the end of actual data has been reached.

6. The method of claim 5, wherein detecting that the end of actual data has been requested comprises detecting a NUL file entry.

7. The method of claim 1, further comprising:
detecting an invalid content source, wherein the content source is invalid because of at least one of a remote data store being removed from a network, a remote data store being powered down, a remote data store being overloaded, network limitations, or network accessibility;
reporting an error;
receiving a request to define the error; and
responding with an indication that the content source is invalid.

8. The method of claim 1, further comprising at least one of enumerating a directory or buffering a file.

9. In a computing environment including a processor that accesses data from files that may be of an unknown file size, files with a file size larger than that allowed by a file system used by the processor, or streaming files with a potentially unlimited file size, one or more computer readable media including a plurality of data fields facilitating accessing files, the computer readable media comprising:
a virtual first data structure, the virtual first data structure comprising virtual addresses based on identifiers for one or more directories or files; and
a virtual second data structure, wherein the data in the virtual first data structure is one or more shared address ranges of the virtual second data structure, the one or more shared address ranges usable for addressing actual data for a file corresponding to an identifier directory depending on the reading of a virtual address based on the identifier, wherein the shared address range comprises a finite address range, and wherein the shared address range is circular such that if the addresses for the file or directory addressed in the first data structure exceeds the size of the finite address range, portions exceeding the finite address range can be accessed by accessing addresses starting at the beginning of the shared address range.

10. The computer readable media of claim 9, wherein the computer readable media further comprise a third data structure, the third data structure comprising an enumeration of file or directory entries, type designators indicating whether an entry is a file or directory, and identifiers corresponding to the identifiers in the first data structure.

11. The computer readable media of claim 10, wherein the first and second data structures are embodied in a memory medium connected to a network processor and computer executable instructions executable by the network processor, and the third data structure is embodied in a memory medium connected to a media decoder processor and computer executable instructions executable by the media decoder processor.

12. The computer readable media of claim 10, wherein a root directory identifier is well known and as such an entry for the root directory is excluded from the third data structure.

13. The computer readable media of claim 10, wherein meta and thumb files associated with a directory or file are excluded from the third data structure, but nonetheless identified in the first virtual data structure with identifiers related to an identifier for the directory or file associated with the meta and thumb files.

14. The computer readable media of claim 9, wherein at least one of the one or more shared address ranges addresses is sized to support reasonable trick mode operation to allow for appropriate fast-forward and rewind functionality.

15. The computer readable media of claim 9, wherein the directories or files are stored on a remote file system.

16. The computer readable media of claim 9, wherein the directories or files are stored on one or more local computer readable storage media.

17. The computer readable media of claim 9, wherein the second data structure comprises a plurality of shared address ranges.

18. The computer readable media of claim 17, wherein the plurality of shared address ranges includes at least one low bandwidth shared address range designated for directory enumeration; at least one low bandwidth shared address range designated for low bandwidth media file access and at least one high bandwidth shared address range designated for high bandwidth media file access.

19. In a computing environment including a processor that accesses data from files that may be of an unknown file size, files with a file size larger than that allowed by a file system used by the processor, or streaming files with a potentially unlimited file size, one or more computer readable media including a plurality of data fields facilitating accessing files, the computer readable media comprising:
a first data structure, the first data structure comprising:
a first field including an enumeration of file or directory entries;
a second field including an enumeration of type designators indicating whether an entry is a file or directory; and
a third field including identifiers corresponding to virtual addresses in a virtual second data structure, the virtual second data structure comprising mapping to a third virtual data structure, the third virtual data structure comprising one or more shared address ranges usable as addresses for directory or file addresses depending on the selection of a virtual address corresponding to an identifier for a directory or file.

20. The computer readable media of claim 19, wherein meta and thumb files associated with a directory or file are excluded from the first data structure, but nonetheless identified in the virtual second data structure with identifiers related to an identifier for the directory or file associated with the meta and thumb files.
